(19) United States
(12) Patent Application Publication
(10) Pub. No.: US 2008/0297726 A1
(43) Pub. Date: Dec. 4, 2008

(54) PROJECTION SYSTEM FOR AUTOMOTIVE AND OTHER APPLICATIONS

(75) Inventors: Ernesto M. RODRIGUEZ, JR., Austin, TX (US); Joseph C. Carls, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/103,803

(22) Filed: Apr. 16, 2008

Related U.S. Application Data
(60) Provisional application No. 60/941,507, filed on Jun. 1, 2007.

(51) Int. Cl. G03B 21/60; G03B 21/14

(52) U.S. Cl. 353/13; 359/443

(57) ABSTRACT

A projection system includes a projection device and a viewing surface. The projection device is configured to project an image onto the viewing surface. The viewing surface has a first side and a second side. The viewing surface is substantially diffuse reflective when viewed from the first side and substantially transparent when viewed from the second side. The viewing surface can also include a plurality of louvers adapted to attenuate light passing through the viewing surface. The viewing surface and the plurality of louvers can be part of a projection screen. The projection system can be included in a motor vehicle.

### CROSS REFERENCE TO RELATED APPLICATION

This application claims the benefit of U.S. Provisional Patent Application No. 60/941507, filed Jun. 1, 2007, the disclosure of which is incorporated by reference herein in its entirety.

### TECHNICAL FIELD

The present invention relates to a projection system, in particular a short throw distance projection system, for use in automotive and other applications.

### BACKGROUND

Projection systems are devices capable of presenting video or electronically generated images. Whether used in home or personal entertainment, advertising, videoconferences, or group conferences, the demand exists for an appropriate projection system.

Image quality is one of the factors consumers use to determine the appropriate projection system. In general, image quality can be determined qualitatively by factors such as image resolution and image color. As the desire by some consumers is for projection systems having larger picture size, image quality can suffer.

While many projection systems are available on the market today, there is a continuing need to develop other systems, e.g., for the automobile, airline, and dynamic signage markets.

### SUMMARY

In one aspect, the present invention provides a projection system comprising a projection device and a viewing surface having a first side and a second side, wherein the viewing surface is substantially diffuse reflective when viewed from the first side and substantially transparent when viewed from the second side. The projection device includes an optical engine configured to project an image, such as a moving image, onto the viewing surface. The optical engine may be disposed in a housing. Optionally, the viewing surface includes a perforated projection screen and may have a plurality of louvers adapted to attenuate light passing through the viewing surface. The plurality of louvers may be adapted to an angle of incoming light rays.

In another aspect, the present invention provides a projection screen including a viewing surface and a plurality of louvers connected to the viewing surface and adapted to attenuate light passing through the viewing surface. The viewing surface includes a first side and a second side and is substantially diffuse reflective when viewed from the first side and substantially transparent when viewed from the second side. Optionally, the plurality of louvers is adapted to an angle of incoming light rays.

In yet another aspect, the present invention provides a motor vehicle having a projection system including a projection device and a viewing surface. The viewing surface includes a first side and a second side and is substantially diffuse reflective when viewed from the first side and substantially transparent when viewed from the second side. The projection device includes an optical engine configured to project an image, such as a moving image, onto the viewing surface. In one aspect, at least one of the projection device and the viewing surface is positioned in a rear passenger compartment of the motor vehicle. The projection device may be coupled to a ceiling or a floor board of the motor vehicle, positioned in an internal compartment of a ceiling or a floor of the motor vehicle, or co-located with a dome light of the motor vehicle.

The above summary of the present invention is not intended to describe each disclosed embodiment or every implementation of the present invention. The Figures and detailed description that follow below more particularly exemplify illustrative embodiments.

### BRIEF DESCRIPTION OF THE DRAWINGS

FIGS. 1A-1B are side views of exemplary embodiments of a projection system according to the present invention.

FIG. 2 is a schematic representation of an exemplary optical engine that can be used in a projection device of the present invention.

FIG. 3 is a schematic representation of exemplary projection optics that can be used in an optical engine of the present invention.

FIGS. 4A-4B are schematic representations of exemplary projection optics that can be used in an optical engine of the present invention.

FIG. 5 is a fragmentary perspective view of an exemplary embodiment of a viewing surface according to an aspect of the present invention.

FIGS. 6A-6B are cross-sectional views of another exemplary embodiment of a viewing surface according to an aspect of the present invention.

FIGS. 7A-7B are cross-sectional views of another exemplary embodiment of a viewing surface according to an aspect of the present invention.

FIG. 8 is a cross-sectional view of another exemplary embodiment of a viewing surface according to an aspect of the present invention.

FIG. 9 is a cross-sectional view of another exemplary embodiment of a viewing surface according to an aspect of the present invention.

FIG. 10 is a side view of an exemplary embodiment of a projection system including a viewing surface comprising a plurality of louvers according to an aspect of the present invention.

FIG. 11 is a side view of another exemplary embodiment of a projection system including a viewing surface comprising a plurality of louvers according to an aspect of the present invention.

FIGS. 12A-12B are side and top views respectively of an exemplary embodiment of a motor vehicle according to an aspect of the present invention.

FIG. 13 is a side view of another exemplary embodiment of a motor vehicle according to an aspect of the present invention.

### DETAILED DESCRIPTION

In the following detailed description of the preferred embodiments, reference is made to the accompanying drawings that form a part hereof. The accompanying drawings show, by way of illustration, specific embodiments in which the invention may be practiced. It is to be understood that other embodiments may be utilized, and structural or logical changes may be made without departing from the scope of the present invention. The following detailed description, therefore, is not to be taken in a limiting sense, and the scope of the invention is defined by the appended claims.

The present invention relates to a projection system having a projection device and a viewing surface. In one exemplary embodiment, the viewing surface is substantially diffuse reflective when viewed from one side and substantially transparent when viewed from another side. In another exemplary embodiment, the viewing surface is substantially diffuse reflective when viewed from one side and substantially transparent when viewed from another side, and the projection system is a short throw distance projection system, wherein the projection device has an optical engine producing an image at a short throw distance.

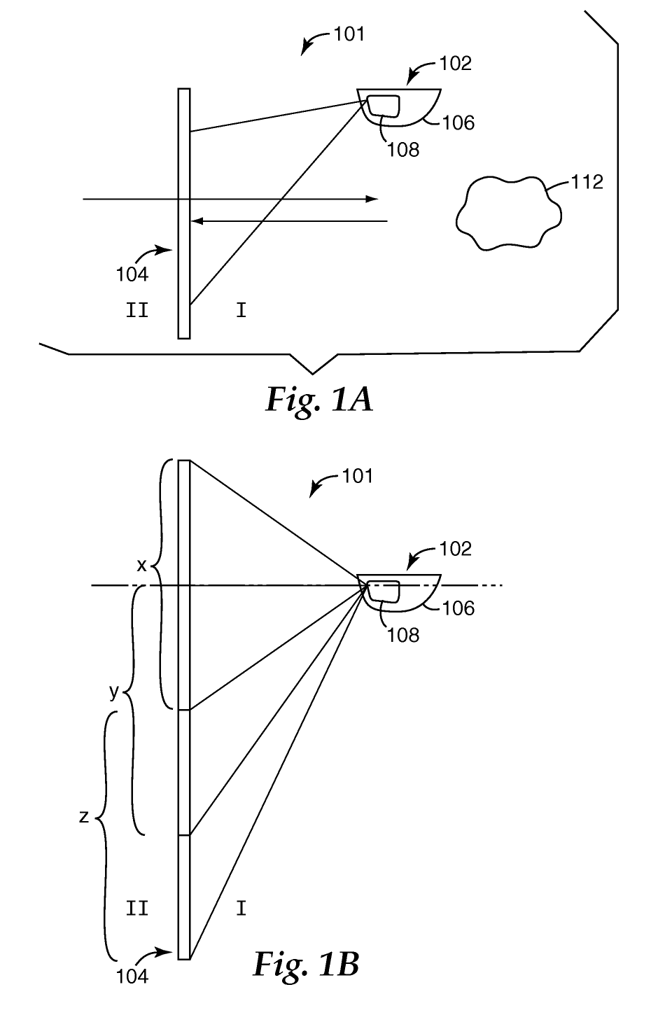

FIG. 1A shows an exemplary embodiment of a projection system according to the present invention. Projection system 101 includes projection device 102 and viewing surface 104. Projection device 102 can project a received image (e.g. a 4×3 format image or a 16×9 format image) onto viewing surface 104.

Projection device 102 includes optical engine 108. In one aspect, projection device 102 also includes a housing 106 that is preferably constructed from a lightweight, yet rugged material, such as a thermoplastic resin (e.g. polycarbonate).

Optical engine 108 includes an illumination source and an imaging system capable of projecting an electronic image onto a viewing surface. In a preferred aspect, optical engine 108 can provide a relatively large image size with high quality and at a short throw distance. Typically, in automotive or other motor vehicle applications, a large picture size is one that equals or exceeds about a 15 inch screen size as measured along the diagonal of the screen. In a preferred aspect, optical engine 108 can be an optical engine such as described in U.S. Pat. Nos. 7,126,767; 7,123,426; 7,173,777; 7,271,964; 7,342,723; and pending U.S. Publication No. 2006/0285090-A1, and Publication No. 2005/0122484-A1.

In one aspect, optical engine 108 can be disposed in a housing 106. In another aspect, optical engine 108 can be disposed in a contained area, such as a roof, floor or door compartment in a motor vehicle, without an external housing.

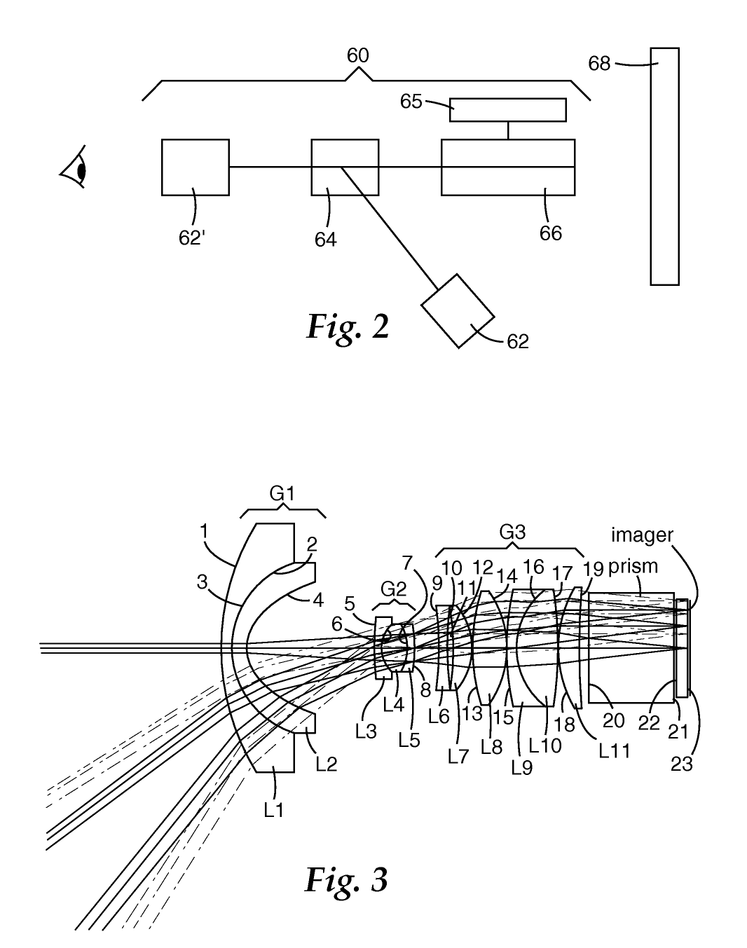

Specific embodiments of the optical engine and projection lens are described in greater detail below with respect to FIGS. 2, 3, 4A, and 4B. A protective lens cap (not shown) can be provided to cover the outer surface of the projection lens when the projection system is not in use. Projection device 102 may also include a plurality of input/output ports or jacks (not shown) which can be used to couple a sound/video image source, such as emanating from a video player (e.g. DVD player, VCR, MPEG player, gaming system, or computer), to the projection device. The input/output ports or jacks can be configured to receive standard electronic connectors (e.g. RCA plugs, s-video, HDMI, etc.). Projection device 102 may also include one or more mounting features (not shown) for mounting the projection device e.g. to a base (e.g. ceiling, wall, door, interior compartment of a motor vehicle, or mounting frame). Projection device 102 may be mounted rotatably, e.g. to a multi-position turret. In addition, projection device 102 may include a control panel (not shown) which provides a user with access to a control menu and to adjust parameters of the projected image, such as image size, image distance, or image distortion (both linear (such as keystoning) and non-linear (such as barrel distortion)). In an exemplary aspect, the control panel can be accessed both manually and through the use of a remote control device (not shown). As shown in FIG. 1A, optical engine 108 is disposed in housing 106. In addition, housing 106 can further contain speakers (not shown) and audio output jacks in addition to, or in place of, the speakers, in order to output sound on external speakers (not shown). In addition, cooling components, a power supply, and/or further control electronics can be disposed in housing 106. Projection device 102 can be provided with wireless connectivity features, e.g. to wirelessly connecting the projection device to peripherals, such as a DVD player, VCR, MPEG player, gaming system, or computer.

Viewing surface 104 is substantially diffuse reflective when viewed from a first side (side I) and substantially transparent when viewed from a second side (side II). The diffuse reflective and transparent functions of the viewing surface can be determined by the amount of light transmission and visibility through the viewing surface, i.e. the amount of open area in the viewing surface. In the exemplary embodiment shown in FIG. 1A, viewing surface 104 is substantially diffuse reflective when viewed from the side on which projection device 102 is located (side I). This allows a person located on side I to see an electronic image, such as a dynamic or moving image, projected by projection device 102 onto viewing surface 104. To accommodate this function, viewing surface 104 can have an open area of about 75% or less, preferably 50% or less, more preferably 25% or less. In one aspect, the non-open area is preferably a material or color of high diffuse reflectance such as white. When viewed from side II, viewing surface 104 is substantially transparent. Thus, a person located on side II will not be able to see the image projected by projection device 102 and will be able to see a substantial amount (e.g. 25% or more) of rear view 112. To accommodate this function, viewing surface 104 can have an open area of about 25% or more, preferably 50% or more, more preferably 75% or more. In one aspect, the non-open area on side II is preferably a material of very low diffuse reflectance and generally dark or even black color. To accommodate both the substantially diffuse reflective function and the substantially transparent function of viewing surface 104, viewing surface 104 can have an open area of 25% to 75%, preferably 35% to 65%, more preferably 45% to 55%. For an open area of 50%, the overall transmissivity of the viewing surface is also about 50% as viewed from side II.

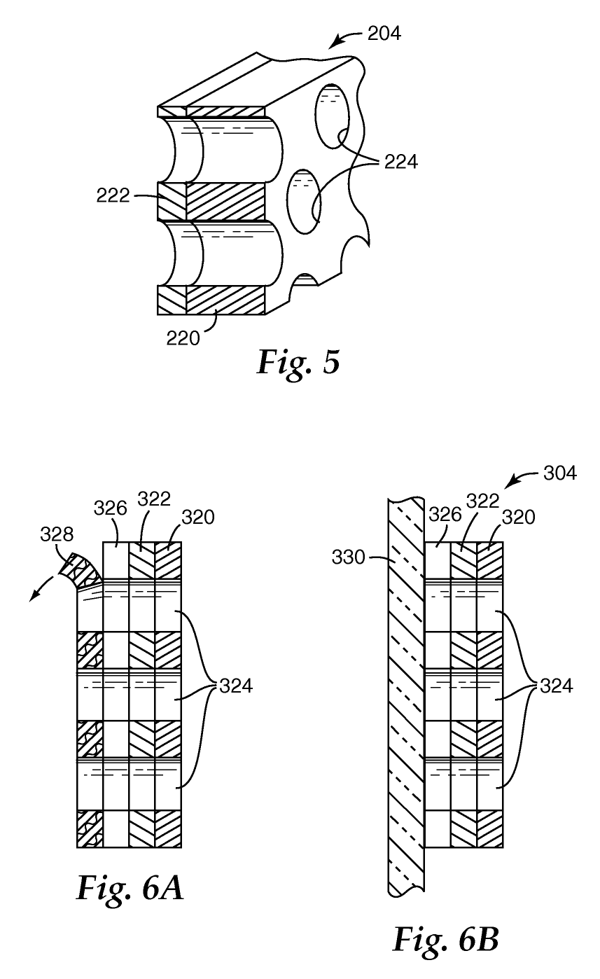

In one exemplary embodiment, viewing surface 104 is a perforated projection screen. The perforated projection screen can comprise a number of stacked layers, including a first layer provided with a light-reflective coating configured to facilitate projection of an electronic image, and a second layer provided with a light-absorbing dark or black coating. The layers are stacked together and perforated with a plurality of through-holes which allow light transmission through the layer assembly. The holes can be placed through the layers either before or after the layers are assembled. Typically, the holes are formed after the layers have been assembled into the layer assembly. The holes allow viewing through the layer assembly in one direction without seeing the projected electronic image, yet the projected electronic image can be viewed by looking at the layer assembly from the opposite direction. The size of the holes and number density can be optimized for the best viewing experience as well as to comply with any laws or regulations that may apply with regard to minimum transparency of the viewing surface, e.g. in automotive or other motor vehicle applications. The size of the holes is preferably on the order of 0.025 mm to 5 mm or larger. Exemplary embodiments of viewing surface 104 can be constructed based on the information provided in U.S. Pat. No. 5,609,938, incorporated by reference herein in its entirety. FIGS. 5-9, described in further detail below, provide several exemplary embodiments of the viewing surface and its construction.

Projection device 102 and viewing surface 104 of projection system 101 can be positioned in any suitable or desired location relative to each other. Adjustments to projection system 101 may be made, e.g. to optimize the quality of the projected image as viewed by a person located on side I and/or to minimize obstruction or hindrance of rear view 112 by a person located on side II. Adjustments can be made to projection device 102 and/or viewing surface 104 in various ways that may be applied individually or in combination. For example, optical engine 108 of projection device 102 can include an offset, wherein the center-line of the image does not lie on the optical axis (e.g., the offset may be vertical, horizontal, or a combination thereof). In one exemplary embodiment, a suitable offset can be from 100% (i.e. the top center of the image is on the optical axis) to 200% (whereby with the offset vertically downwards, the top of the image lies in the same vertical position as the bottom of an image with 0% offset). Another example of an adjustment that can be made to projection system 101 is to rotate projection device 102 and/or optical engine 108 thereof. In this case, corrections for resulting keystoning or other image distortions can be made electronically and/or by rotating viewing surface 104. Another example of an adjustment that can be made to projection system 101 is to use a shaped imager as part of optical engine 108 of projection device 102. Also, viewing surface 104 may include a plurality of louvers (as discussed in detail below) that can play a role in adjusting projection system 101. FIG. 1B is a graphic illustration of an exemplary adjustment of the location of viewing surface 104 relative to projection device 102 by applying an offset to optical engine 108. Positions X, Y, and Z illustrate the position of viewing surface 104 when the offset is 0%, 100%, and 200% respectively.

One of the factors in designing a projection system for a specific application is the throw ratio of the optical engine that is used. The throw ratio is defined herein as the ratio of the distance between the viewing surface and the first lens group of the optical engine to the width of the projected image. In exemplary embodiments of the present invention, the optical engine has a throw ratio about 2.0 or less, preferably about 1.5 or less, most preferably about 1.0 or less. In one exemplary embodiment of the present invention, the distance between the viewing surface and the first lens group of the optical engine is 18 inches, and the width of the projected image is 30 inches. This results in a throw ratio of 18/30=0.6. In another example, the distance between the viewing surface and the first lens group of the optical engine is 30 inches, and the width of the projected image is 20 inches. This results in a throw ratio of 30/20=1.5. In one exemplary embodiment, the throw ratio can be made variable through the use of a zoom lens incorporated in the optical engine.

As mentioned above, the projection system of exemplary embodiments of the present invention can include an optical engine capable of projecting a quality image of a relatively larger size (greater than e.g. 15 inches diagonal) at a short throw ratio. FIG. 2 shows a schematic representation of an exemplary optical engine 60 having one or more of the following components: illumination system 62 or 62′, imaging system 64, a focus mechanism 65, and projection optics 66. While two different illumination systems 62 and 62′ are shown, typically only one is used. When the illumination system lies in position depicted by reference number 62, the imager used is a reflective imager. In contrast, when the illumination system lies in position depicted by reference number 62′, the imager used is a transmissive imager. The optical engine can generate an image on a projection screen or a viewing surface 68. Each element in the optical engine is discussed in detail below.

The illumination system 62, 62′ can include a lamp unit, a filter (such as an infrared light and/or an ultraviolet light rejection filter), a color separation means, and an integrator. In one exemplary embodiment, the lamp unit includes a reflector and a lamp. Suitable, commercially available lamps include (i) Philips UHP type lamp unit, which uses an elliptic reflector, from Philips Semiconductors, Eindhoven, The Netherlands and (ii) OSRAM P-VIP 250 lamp unit from OSRAM GmBH, Munich, Germany. Other suitable lamps and lamp unit arrangements can be used in the present invention. For example, metal halide lamps, tungsten halogen lamps, lasers, or solid state sources, such as light emitting diodes (LEDs), can be used. In one example, for a lower cost unit, a lower power (e.g., 50 Watt-100 Watt), high pressure Hg lamp (commercially available from companies such as Osram and Philips) can be utilized. In an alternative implementation an LED solid state light source, available from such companies as Osram, Cree, and Luminus, can be utilized. In one aspect, an LED illumination system, e.g., color combiner technology, such as described in pending U.S. Provisional Patent Application Nos. 60/938834, 61/017190, and 61/017194, may be used.

The type of filter, color wheel, and integrator that can be used in embodiments of the present invention are not critical. In one exemplary embodiment, the color separation means is a spinning red/green/blue (RGBRGB) or red/green/blue/white (RGBW) color sequential disc in the light source of the imager. An illustrative commercially available color wheel is the UNAXIS RGBW color wheel, from UNAXIS Balzers, LTD, Balzers, Liechtenstein. Alternatively, a 44 mm RGBW color wheel (with 40 degree White Segment) can be utilized. A liquid crystal RGB color sequential shutter can also be used in embodiments of the present invention. For LED light sources, a color separation means may not be necessary when using colored LED solid state light sources. An illustrative commercially available integrator is a hollow tunnel type integrator from UNAXIS Balzers LTD.

The imaging system 64 can include an imager and typically can also include conventional electronics. A useful reflective imager that can be used in the present invention is an XGA digital micromirror device (DMD) having a diagonal dimension of about 22 mm, available from Texas Instruments, Dallas, Tex. For a lower cost projector, a 480p or SVGA-type DLP device available from Texas Instruments, Dallas, Tex., can be utilized. Alternatively, a transmissive or reflective liquid crystal display (LCD or FeLCD) or liquid crystal on silicon (LCOS or FLCOS) can be used as the imager. It is known in the art that, in addition to changes to the lens design, a different imager size would impact the throw ratio.

For some implementations, a focusing mechanism 65 can be accomplished by mounting one or more of the lenses described below on a slidable or threaded mount (not shown), which can be adjusted manually by hand or through the use of an electronic actuation mechanism. For example, focusing can be accomplished by using a varifocal or a zoom lens.

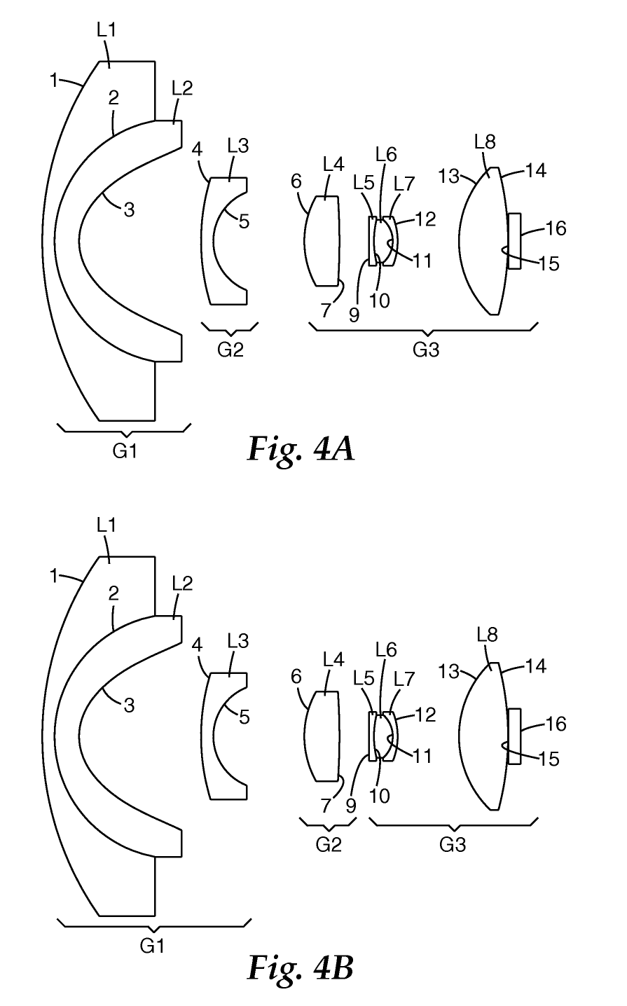

FIG. 3 shows an exemplary embodiment of projections optics (also referred to herein as a “projection lens” or a “wide-angle projection lens”) of the optical engine 60. The projection optics of FIG. 3 include three lens groups in the following sequential order from a screen side: first lens group (G1), second lens group (G2), and third lens group (G3). The term “screen side” means that side of the projection lens closest to a projection screen. The three lens groups are discussed in detail below. As would be apparent to one of ordinary skill in the art given the present description herein, alternative constructions of projection lens 16 can be employed, including alternative constructions that include fewer, the same, or greater numbers of lens elements. (See e.g. the embodiments of FIGS. 4A and 4B.)

The exemplary projection lens of FIG. 3 includes a total of eleven (11) elements in the three lens groups, numbered from the screen side. The first lens group (G1) can include, in order from the screen side, a first lens element (L1) of negative refractive power and a second lens element (L2) having an aspheric surface on its second surface. Preferably, G1 is of negative refractive power. The ratio of F₁/F in G1 can be such that −3.5<F₁/F<−2.3. The second lens group (G2) can include three lens elements, (L3) to (L5) inclusive, affixed or cemented together using a conventional adhesive. Preferably, G2 is substantially zero refractive power. In another embodiment, G2 can be slightly positive in refractive power. In another embodiment, it can be slightly negative in refractive power. The ratio of F₂/F in G2 can be such that −95<F₂/F<−86. In this exemplary embodiment, the aperture stop lies within or near the second lens group G2. The third lens group (G3) can include six lens elements (L6) to (L11) inclusive. Preferably, G3 is of positive refractive power. The ratio of F₃/F in G3 can be such that 2.5<F₃/F<3.2. As shown in FIG. 3, a prism lies to the right of L11, i.e., furthest away from the projection screen. In the above description, F is the focal length of the wide-angle projection lens, F₁ is the focal length of the first lens group, F₂ is the focal length of the second lens group, and F₃ is the focal length of the third lens group.

In more detail, the first lens group G1 is preferably of negative refractive power. In a first embodiment, the first lens group G1 comprises a plurality of lens elements. For example, a first lens element (L1), lying closest to the screen, can have the largest diameter of all the lenses in the three lens groups. In one exemplary embodiment, the first lens element L1 in the first lens group has a sufficiently large diameter to project an image at a large field, i.e., at a half field angle greater than 45°, preferably greater than 50°, and most preferably about 55° in the direction of the screen, with substantially no distortion.

In another exemplary embodiment, the first lens element L1 in the first lens group has a diameter greater than 60 mm and less than 75 mm. In yet another exemplary embodiment, the first lens element of the first lens group has a diameter of less than about 70 mm. Thus, when implemented in a projection device, the first lens element can provide a field of view of about 110° to about 120°.

In the embodiment of FIG. 3, the first lens group G1 further includes a second lens element (L2) having at least one aspheric surface. The aspheric surface of the present exemplary embodiment can help reduce distortion effects, while still providing a large field of view. In one aspect, the second lens element can be fabricated from an optical polymer having a refractive index of about 1.49 and an Abbe number of about 57.2, such as polymethyl methacrylate (PMMA). The shape of the aspheric surface can be defined by the equation below:

$$Z = \frac{{cr}^{2}}{1 + \sqrt{1 - ( 1 + k ) {c}^{2} {r}^{2}}} + {α}_{2} {r}^{2} + {α}_{4} {r}^{4} + {α}_{6} {r}^{6} + {α}_{8} {r}^{8} + {α}_{10} {r}^{10} \qquad Equation I$$

where
Z is the surface sag at a distance r from the optical axis of the system
c is the curvature of the lens at the optical axis in

$$\frac{1}{mm}$$

r is the radial coordinate in mm
k is the conic constant
α₂ is the coefficient for second order term, α₄ is the coefficient for fourth order term, α₆ is the coefficient for sixth order term, α₈ is the coefficient for eighth order term, and α₁₀ is the coefficient for tenth order term.

In another embodiment, the second surface of the first element of the first lens group has a radius of curvature substantially equal to the radius of curvature of the first surface of the second lens element in the first lens group.

In one embodiment, the first lens group G1 includes two meniscus shaped, nested lens elements, a first meniscus shaped element made of glass and a second meniscus shaped element made of plastic, with controlled thickness on the plastic element. A plastic such as PMMA can be used. The two elements are spaced apart such that the ratio of the distance between the second surface of the first element and the first surface of the second element to the overall effective focal length of the projection lens is 1/175.

In an exemplary embodiment, the second shaped element comprises an aspheric lens (e.g., a lens having at least one aspheric surface) having a substantially uniform thickness throughout. This dome-shaped design can reduce thermal problems and can provide for straightforward manufacturing.

In an alternative embodiment, the first lens group G1 can comprise two shaped elements molded together to form one integral element. For example, the first shaped element can comprise a glass element and the second shaped element can comprise a plastic (e.g., PMMA) element molded onto the second surface of the first shaped element.

In another alternative, the first lens group GI can comprise a single element (e.g., a single glass element), with an aspheric surface formed on the first surface, second surface, or both surfaces of the single element.

In another exemplary embodiment, the second lens group G2 can be of substantially zero refractive power. The second lens group can be formed of a plurality of lens elements. The aperture stop of the projection lens 16 can lie within or near the second lens group. For example, in one embodiment, referring to FIG. 3, the aperture stop is provided at about L5.

In an exemplary embodiment, all lens elements in the second lens group can have spherical surfaces. In one exemplary embodiment, the second lens group G2 includes a cemented triplet to help control spherical aberration and coma. The on-axis spacing between the lens elements in G1 and the lens elements in G2 can be varied, if desired.

In an exemplary embodiment, the second lens group G2 provides a longer effective focal length. In addition, in an exemplary embodiment, the elements that make up the second lens group are formed from glass.

In an alternative embodiment, a doublet can be used for the second lens group G2. In this alternative embodiment, one or both of the doublet elements can include an aspheric surface.

In another exemplary embodiment, the third lens group G3 can be of positive refractive power and all lens elements in this lens group can have spherical surfaces. In an exemplary embodiment, the third lens group G3 provides color aberration correction (i.e., primary and secondary dispersion compensation). For example, lenses L7, L8, L10, and L11 can comprise the same glass material, e.g., MP 52. Alternatively, other glasses may also be utilized.

A prism (e.g., a TIR prism, not shown) can be disposed between the third lens group G3 and the imager 14, for example, at a location furthest away from the screen side. Alternatively, a field lens or a non-telecentric lens can be utilized.

By way of example, for the embodiment shown in FIG. 3, Table 1 below lists the surface number, in order from the screen side (with surface 1 being the surface closest to the screen side of the first lens element L1), the curvature (c) near the optical axis of each surface (in 1/millimeters), the on axis spacing (D) between the surfaces (in millimeters), and the glass type is also indicated. One skilled in the art will recognize that from the glass type, it is possible to determine the index of refraction and Abbe number of the material. Surface 0 is the object surface or the surface of the projection screen. In this embodiment, the wide-angle projection lens has an effective overall focal length of 8.8 mm, a half field angle of 55° in the direction of the screen side and operates at F/2.8. The first lens group G1 has an effective focal length of −25.4 mm; the second lens group G2 has an effective focal length of −800 mm; and the third lens group G3 has an effective focal length of 23.5 mm. The projection lens has a total track of 130 mm in this exemplary embodiment.

For the embodiment in FIG. 3, the second surface of the second lens element in the first lens group (denoted as surface 4 in Table 1) is aspheric, as governed by Equation I above, and has the following values for the coefficients: c=0.0901, k=−0.8938, α₂=0, α₄=1.99×10⁻⁵, α₆=−7.468×10⁻⁸, α₈=3.523×10⁻¹⁰, and α₁₀=−5.970×10⁻¹³. The wide-angle projection lens of the embodiment of FIG. 3 has a total track distance of 130 mm. As one skilled in the art will appreciate, in certain applications, such as front-projection display applications, it can be advantageous to have a short total track distance because it would result in a compact projection lens thus minimizing the space requirements of the overall optical engine.

TABLE 1

| Surface No. | C (mm⁻¹) | D (mm) | Glass Type |
|---|---|---|---|
| 0 | 0 | 755 | |
| 1 | 0.0143 | 3.00 | SK16 |
| 2 | 0.0397 | 0.05 | |
| 3 | 0.0397 | 4.00 | Plastic |
| 4* | 0.0901 | 35.7 | |
| 5 | 0.0134 | 1.87 | N-LAF34 |
| 6 | 0.110 | 7.20 | F2 |
| 7 | −0.0796 | 2.00 | N-LAF34 |
| 8 | −0.0214 | 6.78 | |
| 9 | −0.0124 | 2.33 | N-LAK8 |
| 10 | 0.0117 | 1.49 | |
| 11 | −0.0148 | 5.35 | N-PK52 |
| 12 | −0.0553 | 0.187 | |
| 13 | 0.0178 | 9.48 | N-PK52 |
| 14 | −0.0365 | 0.187 | |
| 15 | 0.0110 | 2.40 | PBH6 |
| 16 | 0.0486 | 11.5 | N-PK52 |
| 17 | −0.00866 | 0.187 | |
| 18 | 0.0313 | 5.99 | N-PK52 |
| 19 | 0.00432 | 2.69 | |
| 20 | 0 | 23.4 | BK7 |
| 21 | 0 | 1.00 | |
| 22 | 0 | 3.00 | FK5 |
| 23 | 0 | 0.480 | |
| 24 | 0 | 0 | |

Tables 2 and 3 below list the general lens data and the surface data summary for the embodiment of FIG. 3.

TABLE 2
GENERAL LENS DATA:

| | |
|---|---|
| Surfaces | 24 |
| Stop | 8 |
| System Aperture | Image Space F/# - 3 |
| Glass Catalogs | schott_2000 OLD_SCHO OHARA |
| | CORNING OLD_OHAR MISC |
| Ray Aiming | Real Reference, Cache On |
| X Pupil Shift | 0 |
| Y Pupil Shift | 0 |
| Z Pupil Shift | 0 |
| Apodization | Uniform, Factor = 1.00000E+000 |
| Effective Focal Length | 8.806583 (in air) |
| Effective Focal Length | 8.806583 (in image space) |
| Back Focal Length | 0.4613371 |
| Total Track | 130.237 |
| Image Space F/# | 3 |
| Paraxial Working F# | 3.000816 |
| Working F/# | 2.995898 |
| Image Space NA | 0.1643555 |
| Object Space NA | 0.001891026 |
| Stop Radius | 4.013512 |
| Paraxial Image Height | 13.4 |
| Paraxial Magnification | −0.01134926 |
| Entrance Pupil Diameter | 2.935528 |
| Entrance Pupil Position | 21.1718 |
| Exit Pupil Diameter | 122.5057 |
| Exit Pupil Position | −367.5356 |
| Field Type | Paraxial Image height in millimeters |
| Maximum Field | 13.4 |
| Primary Wave | 0.55 |
| Lens Units | Millimeters |
| Angular Magnification | 0.02396238 |

TABLE 3
SURFACE DATA SUMMARY:

| Surf | Type | Comment | Radius | Thickness | Glass | Diameter | Conic |
|---|---|---|---|---|---|---|---|
| OBJ | STANDARD | | Infinity | 755 | | 2361.387 | 0 |
| 1 | STANDARD | 148-2A | 69.7004 | 3 | SK16 | 70 | 0 |
| 2 | STANDARD | | 25.176 | 0.05 | | 47.55672 | 0 |
| 3 | STANDARD | 20A | 25.176 | 4 | 1.491000, | 48 | 0 |
| | | | | | 57.200000 | | |
| 4 | EVENASPH | | 11.09472 | 35.68789 | | 38 | −0.8938386 |
| 5 | STANDARD | 449-1B | 74.447 | 1.866667 | N-LAF34 | 17 | 0 |
| 6 | STANDARD | NEW | 9.0968 | 7.2 | F2 | 13.5 | 0 |
| 7 | STANDARD | 46-1 | −12.5675 | 2 | N-LAF34 | 13.5 | 0 |
| STO | STANDARD | 565-1B | −46.676 | 6.775973 | | 13.5 | 0 |
| 9 | STANDARD | 169-3A | −80.8308 | 2.333333 | N-LAK8 | 24 | 0 |
| 10 | STANDARD | NEW | 85.79379 | 1.491645 | | 21.2 | 0 |
| 11 | STANDARD | 650-1A | −67.755 | 5.352434 | N-PK52 | 21.2 | 0 |
| 12 | STANDARD | 588-1B | −18.0787 | 0.1866667 | | 24 | 0 |
| 13 | STANDARD | 116-2A | 56.217 | 9.481976 | N-PK52 | 32 | 0 |
| 14 | STANDARD | 700-1B | −27.3991 | 0.1866667 | | 32 | 0 |
| 15 | STANDARD | 665-1B | 91.167 | 2.4 | PBH6 | 33 | 0 |
| 16 | STANDARD | 11A | 20.5695 | 11.47223 | N-PK52 | 33 | 0 |
| 17 | STANDARD | 463-1B | −115.465 | 0.1866667 | | 33 | 0 |
| 18 | STANDARD | 35B | 32 | 5.992456 | N-PK52 | 34 | 0 |
| 19 | STANDARD | 331-1A | 231.217 | 2.692432 | | 34 | 0 |
| 20 | STANDARD | | Infinity | 23.4 | BK7 | 30.90276 | 0 |
| 21 | STANDARD | | Infinity | 1 | | 27.53016 | 0 |
| 22 | STANDARD | | Infinity | 3 | FK5 | 27.31099 | 0 |
| 23 | STANDARD | | Infinity | 0.48 | | 26.87009 | 0 |
| IMA | STANDARD | | Infinity | | | 26.76488 | 0 |

The data provided in the Tables above represent one example and are not intended to limit the scope of the invention described herein.

FIGS. 4A and 4B show two additional exemplary embodiments of projections optics (also referred to herein as a “projection lens” or a “wide-angle projection lens”) of the optical engine 60. The projection optics of FIGS. 4A and 4B include three lens groups (as identified from an output side or screen side): first lens group (G1), second lens group (G2), and third lens group (G3). The term “output side” means that side of the projection lens closest to a viewing surface. The three lens groups are discussed in detail below.

In a first embodiment, the exemplary projection lens of FIG. 4A includes a total of eight (8) elements in the three lens groups, numbered from the output side. In this description, F is the total focal length of the projection lens, F₁ is the focal length of the first lens group, F₂ is the focal length of the second lens group, and F₃ is the focal length of the third lens group.

The first lens group (G1) can include, in order from the screen side, a first lens element (L1) of negative refractive power and a second lens element (L2) having an aspheric surface on its second surface. Preferably, G1 is of negative refractive power. The ratio of F₁/F in G1 can be such that |F₁/F|≧4.5. In one exemplary embodiment, |F₁/F| is about 5.1. In a preferred aspect, the lenses comprising G1 can have a substantially circular shape. Alternatively, the lenses comprising G1 can have a more oblong or oval lens shape with a rectangular aperture, a rectangular lens shape with a rectangular aperture, or a circular lens shape with a rectangular aperture.

The second lens group (G2) can include one lens element, (L3). In this embodiment, G2 is of negative refractive power. The ratio of F₂/F in G2 can be such that 2.5≦|F₂/F|≦6. In one exemplary embodiment, |F₂/F| is about 4.2.

In this exemplary embodiment, the aperture stop lies within the third lens group (G3). The third lens group (G3) can include multiple lens elements, e.g., (L4) to (L8) inclusive. Preferably, G3 is of positive refractive power. The ratio of F₃/F in G3 can be such that 3.8≦F₃/F≦5.0. In one exemplary embodiment, |F₃/F| is about 4.6. In this exemplary embodiment, L8, the lens closest to the illumination input can be considered as a “field lens.”

In a preferred aspect, L8 can be a single structure lens, such as a bi convex or plano-convex lens, having an effective focal length of from about 30 mm to about 40 mm. In an alternative aspect, L8 can have a focal length shorter than 30 mm if using a high index material, such as LaK34 glass to form L8.

In a preferred aspect, the first surface of lens element L8 can have a radius of curvature of about 25 mm. In addition, L8 can be substantially removed from the aperture stop of the projection lens. In another aspect, the curvature of the surface of L8 facing the aperture stop (e.g., surface 13) is greater than the curvature of the surface (e.g., surface 14) facing away from the aperture stop. In another aspect, the distance between L8 and L7 is from about 12 mm to about 17 mm. This spacing provides for a folding mirror to be placed in the optical engine as part of the illumination system.

In a second embodiment, the exemplary projection lens of FIG. 4B includes a total of eight (8) elements in the three lens groups, numbered from the output side. The first lens group (G1) can include a first lens element (L1) of negative refractive power, a second lens element (L2) having an aspheric surface on its second surface, and a third lens element (L3). Preferably, G1 is of negative refractive power. The ratio of F₁/F in G1 can be such that 1.3≦|F₁/F|≦2.0. In one exemplary embodiment, F₁ is from about −9.8 mm to about −11.5 mm.

The second lens group (G2) can include one lens element, (L4). In this embodiment, G2 is of positive refractive power. The ratio of F₂/F in G2 can be such that |F₂/F|≧4.0. In one exemplary embodiment, F₂ is from about 27.5 mm to about 31 mm.

In this exemplary embodiment, the aperture stop lies between the second lens group (G2) and the third lens group (G3). The third lens group (G3) can include multiple lens elements, e.g., (L5) to (L8) inclusive. Preferably, G3 is of positive refractive power. The ratio of F₃/F in G3 can be such that 3.8≦|F₃/F|≦5.0. In one exemplary embodiment, F₃ is from about 26.8 mm to about 30.3 mm.

In this exemplary embodiment, the effective focal length of the entire lens is from about 6.4 mm to about 6.7 mm.

In more detail for the embodiments of FIGS. 4A and 4B, the first lens group G1 comprises a plurality of lens elements. For example, a first lens element (L1), lying closest to the viewing surface or screen, can have the largest diameter of all the lenses in the three lens groups. In one exemplary embodiment, the first lens element L1 in the first lens group has a sufficiently large diameter to project an image at a large field, i.e., at a half field angle greater than 45°, preferably greater than 50°, and most preferably about 55° or greater in the direction of the viewing surface or screen, with substantially no distortion.

For the embodiments of FIGS. 4A and 4B, the effective focal length to image height ratio can be from about 0.5 to 1.0. The effective focal length to image height ratio is determined by taking the effective focal length of the entire lens and dividing this number by the image height of the system. For example, if the lens has an EFL of 6.71 mm and the imager used in the optical engine has a diagonal of 13.4 mm, then the EFL to image height ratio is 6.71/13.4=0.51.

In another exemplary embodiment, the first lens element L1 in the first lens group has a diameter greater than about 60 mm and less than about 100 mm. In yet another exemplary embodiment, the first lens element of the first lens group has a diameter of about 90 mm. Thus, when implemented in a projection device, the first lens element can provide a field of view of about 110° to about 120°.

In the embodiments of FIGS. 4A and 4B, the first lens group G1 further includes a second lens element (L2) having at least one aspheric surface. The aspheric surface of the present exemplary embodiment can help reduce distortion effects, while still providing a large field of view. In one aspect, the second lens element can be fabricated from an optical polymer having a refractive index of about 1.49 and an Abbe number of about 57.2, such as polymethyl methacrylate (PMMA). The shape of the aspheric surface can be defined by the equation below:

$$Z = \frac{{cr}^{2}}{1 + \sqrt{1 - ( 1 + k ) {c}^{2} {r}^{2}}} + {α}_{2} {r}^{2} + {α}_{4} {r}^{4} + {α}_{6} {r}^{6} + {α}_{8} {r}^{8} + {α}_{10} {r}^{10} + {α}_{12} {r}^{12} + {α}_{14} {r}^{14} \qquad ( Equation I )$$

where
Z is the surface sag at a distance r from the optical axis of the system
c is the curvature of the lens at the optical axis in

$$\frac{1}{mm}$$

r is the radial coordinate in mm
k is the conic constant
α₂ is the coefficient for the second order term, α₄ is the coefficient for the fourth order term, α₆ is the coefficient for the sixth order term, α₈ is the coefficient for the eighth order term, α₁₀ is the coefficient for the tenth order term, α₁₂ is the coefficient for the twelfth order term, and α₁₄ is the coefficient for the fourteenth order term.

In one embodiment, the second surface of the first element of the first lens group has a radius of curvature substantially equal to the radius of curvature of the first surface of the second lens element in the first lens group.

In another embodiment, the first lens group G1 includes two meniscus shaped, nested lens elements, a first meniscus shaped element made of glass and a second meniscus shaped element made of a plastic or acrylic, with a controlled thickness on the plastic/acrylic element. A material such as PMMA can be used. The two elements are spaced apart such that the ratio of the distance between the second surface of the first element and the first surface of the second element to the overall effective focal length of the projection lens is 1/175.

In an exemplary embodiment, the second shaped element comprises an aspheric lens (e.g., a lens having at least one aspheric surface) having a substantially uniform thickness throughout. This dome-shaped design can reduce thermal problems and can provide for straightforward manufacturing.

In an alternative embodiment, the first lens group G1 can comprise two shaped elements molded together to form one integral element. For example, the first shaped element can comprise a glass element and the second shaped element can comprise an acrylic or plastic (e.g., PMMA) element molded onto or cemented to the second surface of the first shaped element.

In another alternative, the lens element 1 (L1) and lens element 2 (L2) can comprise a single element (e.g., a single glass element), with an aspheric surface formed on the first surface, second surface, or both surfaces of the single element.

In an exemplary embodiment, the lens element 3 (L3) can have spherical surfaces and can be formed from glass. It provides a long negative effective focal length and its value varies from −2.5F to −6F, where F is the focal length for the entire projection lens.

In another exemplary embodiment, lens element 4 (L4) is a positive lens. Preferably, L4 can be a plano-convex or meniscus lens. In another exemplary embodiment, L4's surface that faces towards L3 (see e.g. surface 6 in the Tables below) can have a small radius of curvature, such that the effective focal length of L4 is larger than 4.0 F. Furthermore, L4 can be used as a focusing element in the projection lens. For a different throw distance, a sharp image can be obtained by moving L4 along the optical axis.

In one exemplary embodiment, the lens elements 5, 6, and 7 (L5, L6, and L7) are formed as a cemented triplet to help control spherical aberration and coma. In an alternative embodiment, a doublet can be used to replace the triplet. In this alternative embodiment, one or both of the doublet elements can include an aspheric surface.

In another exemplary embodiment, the third lens group G3 can be of positive refractive power and all lens elements in this lens group can have spherical surfaces.

In another exemplary embodiment, the aperture stop of the projection lens 66 is located proximate to L5 (e.g., between L4 and L5, as shown in Table 4, or between L5 and L6, as shown in Table 7).

Lenses L5-L7 can comprise the same glass material or different glass materials. Example materials suitable for these lenses include those materials listed in the Tables below and other materials, including, but not limited to, N-SF1, N-SF4, N-SK5, N-SF6, N-LAK8, N-SF16, N-PSK53, N-SF57, and N-BK7, to name a few.

By way of example, for the embodiments shown in FIGS. 4A and 4B, example lenses were modeled. Tables 4, 7, and 10 below list the surface numbers for the three example lenses, in order from the output side (with surface 1 being the surface closest to the output side of the first lens element L1), the curvature (C) near the optical axis of each surface (in 1/millimeters), the on-axis spacing (D) between the surfaces (in millimeters), and the glass or other material type is also indicated. One skilled in the art will recognize that from the glass type, it is possible to determine the index of refraction and Abbe number of the material. Surface OBJ is the object surface or the surface of the viewing surface/screen. Identified surface numbers are shown in FIGS. 4A and 4B, where surfaces 15 and 16 correspond to the window glass of the exemplary DLP imaging device and “IMA” corresponds to the image plane.

In the embodiment as listed in Table 4, the wide-angle projection lens has an effective overall focal length of about 6.47 mm, a half field angle of about 56.58° in the direction of the output side and operates at F/2.6. The back focal length (BFL) is about 5.5 mm (in air). In a preferred aspect, the BFL is less than about 1.4 times the EFL. In addition, the projection lens can have a speed of less than or equal to about F/3.1 or less, and the projection lens generates an image at a half field angle of at least about 50°. For example, a first lens group G1 such as shown in FIG. 4A can have an effective focal length of −31.3 mm; a second lens group G2 such as shown in FIG. 4A can have an effective focal length of −37.5 mm; and a third lens group G3 such as shown in FIG. 4A can have an effective focal length of 30.6 mm. This example projection lens has a total track of 123.3 mm (from L1 to L8) in this exemplary embodiment. In another embodiment, such as is shown in FIG. 4B, a first lens group G1 can have an effective focal length of −11.4 mm; a second lens group G2 can have an effective focal length of 31.0 mm; and a third lens group G3 have an effective focal length of 30.3 mm. This example projection lens has a total track of 123.3 mm in this exemplary embodiment.

For the embodiments in FIGS. 4A and 4B, the second surface of the lens element 2 (L2) (e.g., denoted as surface 3 in Table 4) is aspheric, as governed by Equation I above. The wide-angle projection lens of the embodiment of FIGS. 4A and 4B has a total track distance of about 123.3 mm. As one skilled in the art will appreciate, in certain applications it can be advantageous to have a short total track distance because it would result in a compact projection lens thus minimizing the space requirements of the overall optical engine.

For the following examples, Tables 4-6 correspond to a first example projection lens, Tables 7-9 correspond to a second example projection lens, and Tables 10-12 correspond to a third example projection lens.

TABLE 4

| Surface No. | C (mm⁻¹) | D (mm) | Glass Type |
|---|---|---|---|
| OBJ | 0 | 755 | |
| 1 | 0.0149 | 3 | N-BK7 |
| 2 | 0.0333 | 6 | ACRYLIC |
| 3 | 0.0823 | 32.44433 | |
| 4 | 0.0163 | 3 | N-SK16 |
| 5 | 0.0602 | 30.8284 | |
| 6 | 0.0397 | 4.030861 | N-SF6 |
| 7 | 0 | 9.343294 | |
| STOP | 0 | 1.0 | |
| 9 | 0.0195 | 1.2 | N-SF4 |
| 10 | 0.0799 | 4.447884 | N-SK5 |
| 11 | −0.0966 | 1 | N-SF6 |
| 12 | −0.0384 | 15 | |
| 13 | 0.04 | 12.00451 | N-BK7 |
| 14 | −0.0143 | 3 | |
| 15 | 0 | 3 | 1.472, 62.0 |
| 16 | 0 | 0.483 | |
| IMA | 0 | | |

Tables 5 and 6 below list the general lens data and the surface data summary for the first example lens.

TABLE 5
GENERAL LENS DATA:

| | |
|---|---|
| Surfaces | 17 |
| Stop | 8 |
| System Aperture | Image Space F/# = 2.6 |
| Glass Catalogs | SCHOTT MISC OHARA SCHOTT_2000 |
| Ray Aiming | Paraxial Reference, Cache On |
| X Pupil Shift | 0 |
| Y Pupil Shift | 0 |
| Z Pupil Shift | 0 |
| Apodization | Uniform, Factor = 1.00000E+000 |
| Temperature (C.) | 2.00000E+001 |
| Pressure (ATM) | 1.00000E+000 |
| Effective Focal Length | 6.468447 (in air) |
| Effective Focal Length | 6.468447 (in image space) |
| Back Focal Length | 0.4616339 |
| Total Track | 129.7823 |
| Image Space F/# | 2.6 |
| Paraxial Working F# | 2.602087 |
| Working F/# | 2.643913 |
| Image Space NA | 0.1887066 |
| Object Space NA | 0.001589476 |
| Stop Radius | 4.92572 |
| Paraxial Image Height | 9.810052 |
| Paraxial Magnification | −0.008271678 |
| Entrance Pupil Diameter | 2.487864 |
| Entrance Pupil Position | 27.60445 |
| Exit Pupil Diameter | 26.59854 |
| Exit Pupil Position | −69.17757 |
| Field Type | Angle in degrees |
| Maximum Field | 56.58 |
| Primary Wave | 0.548 |
| Lens Units | Millimeters |
| Angular Magnification | 0.09353387 |

TABLE 6
SURFACE DATA SUMMARY:

| Surf | Type | Comment | Radius | Thickness | Glass | Diameter | Conic |
|---|---|---|---|---|---|---|---|
| OBJ | STANDARD | | Infinity | 755 | | 1116.485 | 0 |
| 1 | STANDARD | | 67.00772 | 3 | N-BK7 | 90 | 0 |
| 2 | STANDARD | | 30 | 6 | ACRYLIC | 37.76403 | 0 |
| 3 | EVENASPH | | 12.15014 | 32.44433 | | 27.88211 | −0.6627935 |
| 4 | STANDARD | | 61.33346 | 3 | N-SK16 | 34 | 0 |
| 5 | STANDARD | | 16.60462 | 30.8284 | | 26 | 0 |
| 6 | STANDARD | | 25.17034 | 4.030861 | N-SF6 | 22 | 0 |
| 7 | STANDARD | | Infinity | 9.343294 | | 22 | 0 |
| STO | STANDARD | | Infinity | 1.0 | | 0 | 0 |
| 9 | STANDARD | | 51.16039 | 1.2 | N-SF4 | 12.5 | 0 |
| 10 | STANDARD | | 12.51071 | 4.447884 | N-SK5 | 12 | 0 |
| 11 | STANDARD | | −10.35593 | 1 | N-SF6 | 12 | 0 |
| 12 | STANDARD | | −26.07301 | 15 | | 13 | 0 |
| 13 | STANDARD | | 25 | 12.00451 | N-BK7 | 36 | 0 |
| 14 | STANDARD | | −70 | 3 | | 36 | 0 |
| 15 | STANDARD | | Infinity | 3 | 1.472, | 9.89623 | 0 |
| | | | | | 62.0 | | |
| 16 | STANDARD | | Infinity | 0.483 | | 9.369676 | 0 |
| IMA | STANDARD | | Infinity | | | 9.243695 | 0 |

Tables 7-9 correspond to a second example projection lens.

TABLE 7

| Surface No. | C (mm⁻¹) | D (mm) | Glass Type |
|---|---|---|---|
| OBJ | 0 | 755 | |
| 1 | 0.0131 | 3 | N-BK7 |
| 2 | 0.0333 | 6 | ACRYLIC |
| 3 | 0.0746 | 29.83529 | |
| 4 | 0.0190 | 3 | N-BAF10 |
| 5 | 0.0774 | 22.2651 | |
| 6 | 0.0447 | 8.582311 | N-SF6 |
| 7 | −0.0062 | 7.244238 | |
| 8 (Dummy) | 0 | | |
| 9 | −0.0011 | 1.2 | N-SF6 |
| STO/10 | 0.0449 | 4.6 | N-SK16 |
| 11 | −0.1414 | 1.2 | N-SF6 |
| 12 | −0.0625 | 15 | |
| 13 | 0.04 | 12.00451 | N-BK7 |
| 14 | −0.0143 | 0.1 | |
| 15 | 0 | 3 | 1.472, 62.0 |
| 16 | 0 | 0.483 | |
| IMA | 0 | | |

Please note that surface number 8 in Table 7 is a dummy surface and that the aperture stop is co-located with surface 10.

Tables 8 and 9 below list the general lens data and the surface data summary for the second example lens.

TABLE 8
GENERAL LENS DATA:

| | |
|---|---|
| Surfaces | 17 |
| Stop | 10 |
| System Aperture | Image Space F/# = 3 |
| Glass Catalogs | SCHOTT MISC OHARA SCHOTT_2000 |
| Ray Aiming | Paraxial Reference, Cache On |
| X Pupil Shift | 0 |
| Y Pupil Shift | 0 |
| Z Pupil Shift | 0 |
| Apodization | Uniform, Factor = 1.00000E+000 |
| Temperature (C.) | 2.00000E+001 |
| Pressure (ATM) | 1.00000E+000 |
| Effective Focal Length | 6.600015 (in air) |
| Effective Focal Length | 6.600015 (in image space) |
| Back Focal Length | 0.5524066 |
| Total Track | 117.5145 |
| Image Space F/# | 3 |
| Paraxial Working F# | 3.002891 |
| Working F/# | 3.024114 |
| Image Space NA | 0.164245 |
| Object Space NA | 0.00140599 |
| Stop Radius | 3.720277 |
| Paraxial Image Height | 9.794352 |
| Paraxial Magnification | −0.008444077 |
| Entrance Pupil Diameter | 2.200005 |
| Entrance Pupil Position | 27.36778 |
| Exit Pupil Diameter | 19.28059 |
| Exit Pupil Position | −57.77236 |
| Field Type | Angle in degrees |
| Maximum Field | 56 |
| Primary Wave | 0.548 |
| Lens Units | Millimeters |
| Angular Magnification | 0.1141047 |

TABLE 9
SURFACE DATA SUMMARY:

| Surf | Type | Comment | Radius | Thickness | Glass | Diameter | Conic |
|---|---|---|---|---|---|---|---|
| OBJ | STANDARD | | Infinity | 755 | | 1580.363 | 0 |
| 1 | STANDARD | | 76.43678 | 3 | N-BK7 | 88 | 0 |
| 2 | STANDARD | | 30 | 6 | ACRYLIC | 59 | 0 |
| 3 | EVENASPH | | 13.39753 | 29.83529 | | 46 | −0.8724296 |
| 4 | STANDARD | | 52.61928 | 3 | N-BAF10 | 31 | 0 |
| 5 | STANDARD | | 12.91721 | 22.2651 | | 24 | 0 |
| 6 | STANDARD | | 22.39428 | 8.582311 | N-SF6 | 22 | 0 |
| 7 | STANDARD | | −160.9595 | 0 | | 22 | 0 |
| 8 | STANDARD | | Infinity | 7.244238 | | 0 | 0 |
| 9 | STANDARD | | −899.3512 | 1.2 | N-SF6 | 12 | 0 |
| STO | STANDARD | | 22.28334 | 4.6 | N-SK16 | 10.5 | 0 |
| 11 | STANDARD | | −7.069801 | 1.2 | N-SF6 | 10.5 | 0 |
| 12 | STANDARD | | −16.00767 | 15 | | 12 | 0 |
| 13 | STANDARD | | 25 | 12.00451 | N-BK7 | 36 | 0 |
| 14 | STANDARD | | −70 | 0.1 | | 36 | 0 |
| 15 | STANDARD | | Infinity | 3 | 1.472, 62.0 | 13.58104 | 0 |
| 16 | STANDARD | | Infinity | 0.483 | | 13.39876 | 0 |
| IMA | STANDARD | | Infinity | | | 13.35556 | 0 |

Tables 10-12 correspond to a third example projection lens.

TABLE 10

| Surface No. | C (mm⁻¹) | D (mm) | Glass Type |
|---|---|---|---|
| OBJ | 0 | 755 | |
| 1 | 0.0119 | 3 | N-BK7 |
| 2 | 0.0333 | 6 | ACRYLIC |
| 3 | 0.0730 | 32.6153 | |
| 4 | 0.0129 | 3 | N-SK16 |
| 5 | 0.0720 | 22.35666 | |
| 6 | 0.0434 | 9.493437 | N-SF6 |
| 7 | −0.0015 | 6.794976 | |
| STO | 0 | 1.0 | |
| 9 | −0.0072 | 1.2 | N-SF1 |
| 10 | 0.0472 | 4.6 | N-SK16 |
| 11 | −0.1380 | 1.2 | N-SF6 |
| 12 | −0.0622 | 15 | |
| 13 | 0.04 | 12.00451 | N-BK7 |
| 14 | −0.0143 | 3 | |
| 15 | 0 | 3 | 1.472, 62.0 |
| 16 | 0 | 0.483 | |
| IMA | 0 | | |

Tables 11 and 12 below list the general lens data and the surface data summary for the third example lens.

TABLE 11
GENERAL LENS DATA:

| | |
|---|---|
| Surfaces | 17 |
| Stop | 8 |
| System Aperture | Image Space F/# = 3 |
| Glass Catalogs | SCHOTT MISC OHARA SCHOTT_2000 |
| Ray Aiming | Paraxial Reference, Cache On |
| X Pupil Shift | 0 |
| Y Pupil Shift | 0 |
| Z Pupil Shift | 0 |
| Apodization | Uniform, Factor = 1.00000E+000 |
| Temperature (C.) | 2.00000E+001 |
| Pressure (ATM) | 1.00000E+000 |
| Effective Focal Length | 6.600098 (in air) |
| Effective Focal Length | 6.600098 (in image space) |
| Back Focal Length | 0.4419799 |
| Total Track | 124.7479 |
| Image Space F/# | 3 |
| Paraxial Working F# | 3.002246 |
| Working F/# | 3.04586 |
| Image Space NA | 0.1642793 |
| Object Space NA | 0.001405376 |
| Stop Radius | 3.97923 |
| Paraxial Image Height | 9.792374 |
| Paraxial Magnification | −0.008438577 |
| Entrance Pupil Diameter | 2.200033 |
| Entrance Pupil Position | 27.71955 |
| Exit Pupil Diameter | 24.79572 |
| Exit Pupil Position | −74.42818 |
| Field Type | Angle in degrees |
| Maximum Field | 56 |
| Primary Wave | 0.548 |
| Lens Units | Millimeters |
| Angular Magnification | 0.08872631 |

TABLE 12
SURFACE DATA SUMMARY:

| Surf | Type | Comment | Radius | Thickness | Glass | Diameter | Conic |
|---|---|---|---|---|---|---|---|
| OBJ | STANDARD | | Infinity | 755 | | 1580.945 | 0 |
| 1 | STANDARD | | 83.68771 | 3 | N-BK7 | 88 | 0 |
| 2 | STANDARD | | 30 | 6 | ACRYLIC | 59 | 0 |
| 3 | EVENASPH | | 13.69548 | 32.6153 | | 46 | −0.8942559 |
| 4 | STANDARD | | 77.23397 | 3 | N-SK16 | 31 | 0 |
| 5 | STANDARD | | 13.89109 | 22.35666 | | 24 | 0 |
| 6 | STANDARD | | 23.0284 | 9.493437 | N-SF6 | 22 | 0 |
| 7 | STANDARD | | −676.6521 | 6.794976 | | 22 | 0 |
| STO | STANDARD | | Infinity | 1.0 | | 0 | 0 |
| 9 | STANDARD | | −138.0564 | 1.2 | N-SF1 | 12 | 0 |
| 10 | STANDARD | | 21.19504 | 4.6 | N-SK16 | 10.5 | 0 |
| 11 | STANDARD | | −7.244446 | 1.2 | N-SF6 | 10.5 | 0 |
| 12 | STANDARD | | −16.08746 | 15 | | 12 | 0 |
| 13 | STANDARD | | 25 | 12.00451 | N-BK7 | 36 | 0 |
| 14 | STANDARD | | −70 | 3 | | 36 | 0 |
| 15 | STANDARD | | Infinity | 3 | 1.472, 62.0 | 13.87837 | 0 |
| 16 | STANDARD | | Infinity | 0.483 | | 13.54066 | 0 |
| IMA | STANDARD | | Infinity | | | 13.46008 | 0 |

The data provided in the Tables above represent only a few examples and are not intended to limit the scope of the invention described herein.

In alternative aspects, the optical engine can include conventional projection optics and/or other components such as described in U.S. Pat. Nos. 5,604,624, 6,439,726, and 7,080,908, each of which is incorporated by reference herein in its entirety. In some applications, a compact design of the projection optics may be desired.

FIGS. 5-9 illustrate different exemplary embodiments of a viewing surface according to the present invention. Generally, the transparent function a viewing surface can be determined by the amount of light transmission and visibility through the viewing surface, i.e. the amount of open area in the viewing surface. The exemplary embodiments of FIGS. 5-9 have an open area in a range of about 50% to 70%.

FIG. 5 shows an exemplary embodiment of a viewing surface according to the present invention. In one aspect, viewing surface 204 can be constructed in a manner the same as or similar to what is taught in U.S. Pat. No. 5,609,938, incorporated by reference herein in its entirety. Viewing surface 204 comprises a panel or layer 220 which is opaque black in color. Panel or layer 220 has a light-reflective coating or layer 222 configured to facilitate the viewing of a projected electronic image. Panel or layer 220, and optionally light-reflective coating or layer 222, is perforated with a plurality of through-holes 224. Through-holes 224 extend completely through panel or layer 220 and light-reflective coating or layer 222. Through-holes 224 are preferably cylindrical (although other shapes may also be applied) and can be formed either before or after light-reflective coating or layer 222 is applied to panel or layer 220. Through-holes 224 permit light to be transmitted through viewing surface 204. Since through-holes 224 extend completely through the entire viewing surface 204, there are no glue or plastic layers which will contribute to undesirable refraction, diffraction, or scattering as light is transmitted therethrough, resulting in improved optical performance. Panel or layer 220 can be made from a variety of suitable materials, including but not limited to plastics, fabrics, vinyls, polyesters, papers, metals, or combinations thereof.

FIG. 6A-6B illustrate another exemplary embodiment of a viewing surface according to the present invention. Viewing surface 304 comprises a panel or layer 326. Panel or layer 326 has a light-reflective coating or layer 322 applied to or printed on one side surface thereof followed by an opaque light-absorbing coating or layer 320 (e.g. black paint). Panel or layer 326 can comprise a static cling material layer. A peel-off liner or backing 328 can be laminated or otherwise applied to panel or layer 326 as shown. As before, the entire assembly is perforated with through-holes 324. FIG. 6B shows the embodiment of FIG. 6A with peel-off liner or backing 328 removed and the assembly mounted to a transparent base substrate 330, such as a transparent glass or plastic (e.g. polymethyl methacrylate) window or panel, thereby completing the assembly of viewing surface 304.

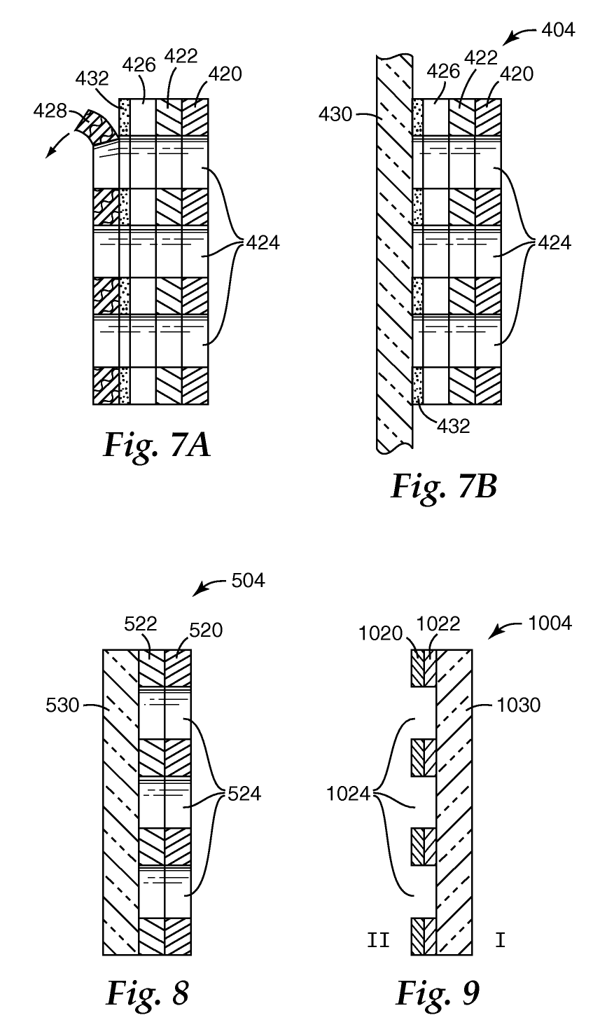

FIG. 7A-7B illustrate another exemplary embodiment of a viewing surface according to the present invention. Similar to the embodiment of FIGS. 6A-6B, viewing surface 404 comprises a panel or layer 426. Panel or layer 426 has a light-reflective coating or layer 422 applied to or printed on one side surface thereof followed by an opaque light-absorbing coating or layer 420 (e.g. black paint). A transfer adhesive 432 and peel-off liner or backing 428 (e.g. a paper backing) are applied to panel or layer 426 as shown. As before, the entire assembly is perforated with through-holes 424. FIG. 7B shows the embodiment of FIG. 7A with peel-off liner or backing 428 removed and the assembly mounted to a transparent base substrate 430, such as a transparent glass or plastic (e.g. polymethyl methacrylate) window or panel, thereby completing the assembly of viewing surface 404.

FIG. 8 shows another exemplary embodiment of a viewing surface according to the present invention. Viewing surface 504 comprises a transparent base substrate 530, such as a transparent glass or plastic (e.g. polymethyl methacrylate) window or panel. Transparent base substrate 530 has a light-reflective coating or layer 522 applied to or printed on one side surface thereof followed by an opaque light-absorbing coating or layer 520. Light-reflective coating or layer 522 and light-absorbing coating or layer 520 include a plurality of through-holes 524. Through-holes 524 can be formed e.g. by perforating light-reflective coating or layer 522 and light-absorbing coating or layer 520, or by including them when printing light-reflective coating or layer 522 and light-absorbing coating or layer 520 on transparent base substrate 530.

In more detail, in another exemplary embodiment shown in FIG. 9, a viewing surface 1004 includes a perforated screen pattern created by printing. Viewing surface 1004 can be created from a transparent substrate 1030. Side II can be printed with a light-reflective (e.g. white) coating 1022 with a plurality of openings 1024 therein (simulating the through-holes in the embodiments described above), followed by being printed with a light-absorbing (e.g. black) coating 1020 on top of and in register with light-reflective coating 1022. This approach creates an effective perforated projection screen without physically perforating the coatings, layers, or substrate.

In other embodiments, the viewing surface may include a light-reflective panel or layer (e.g. white plastic) configured to facilitate projection of an electronic image and coated with an opaque light-absorbing coating. Alternatively, viewing surface may include a panel or layer coated with a light-reflective coating on one side thereof, and coated with an opaque light-absorbing coating on the other side thereof. The panel or layer, the light-reflective coating or layer, and/or the light-absorbing coating or layer may be micro-replicated or embossed with a pattern to increase light directionality and efficiency of the viewing surface. The viewing surface may include a frame to support the structure.

In some exemplary embodiments, the viewing surface may have a projection (use) position and a storage position. When the viewing surface is a projection (use) position, a projected electronic image can be viewed on the viewing surface. When not in use, the viewing surface may be brought into a storage position, thereby preventing physical obstruction to objects that may be moving in the space of the viewing surface in a projection (use) position, preventing visual obstruction (e.g. a rear passenger's front view in a motor vehicle), and protecting the viewing surface. Movement between the projection (use) position and the storage position may be assisted manually or may be motor-driven, and may be accomplished in many different ways, e.g. by using a rolling mechanism (e.g. rolling the viewing surface up and down), a folding mechanism (e.g. folding the viewing surface in and out, or up and down), a tilt mechanism, a swivel mechanism, or combinations thereof. Movement of the viewing surface may be controlled, through a control panel, a remote control, or other control mechanism, independently or in combination with a corresponding projection device.

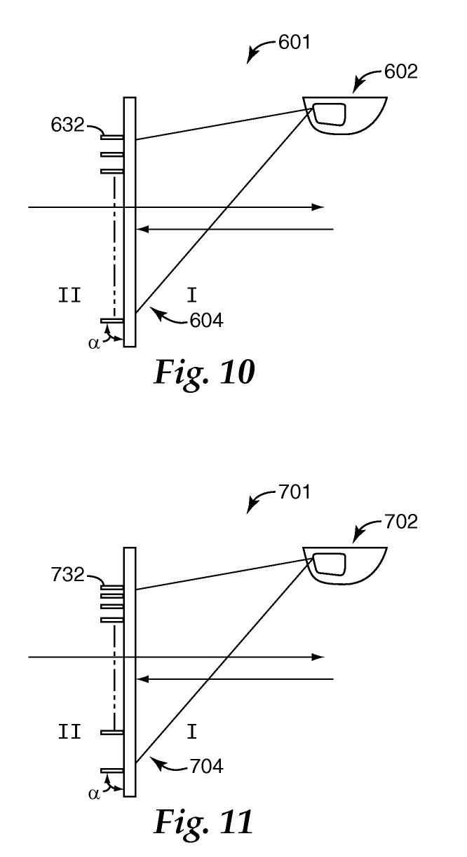

FIG. 10 shows another exemplary embodiment of a projection system according to the present invention. Projection system 601 includes a projection device 602 and a viewing surface 604. Viewing surface 604 can be a perforated screen as described above, and includes a plurality of louvers 632 adapted to attenuate projected light passing through the viewing surface. In FIG. 10, louvers 632 are shown perpendicular to the major axis of viewing surface 604, i.e. the angle α between the major axes of the louvers and the major axis of the viewing surface is about 90°, and are spaced evenly. Angle α can vary from 0° to 180° to provide the viewing surface with the desired diffuse reflectivity when viewed from one side and the desired transparency when viewed from the other side. One of the factors that can determine the optimum louver design (e.g. to accommodate a driver's rear view), specifically angle α and louver spacing, is the angle of incoming light from the projection device. To account for variations in the angle of incoming light from the projection device, angle α, louver spacing, and louver width may be adjusted for each louver across the major axis of the viewing surface.

FIG. 11 shows another exemplary embodiment of a projection system according to the present invention, wherein the louver spacing is adjusted to account for variations in the angle of incoming light from the projection device. Projection system 701 includes a projection device 702 and a viewing surface 704. Viewing surface 704 can be a perforated screen as described above, and includes a plurality of louvers 732 similar to the embodiment illustrated in FIG. 10, but spaced to accommodate the variations in the angle of incoming light from projection device 702.

Preferably, the louvers of the present invention have light-attenuating characteristics resulting from louver design parameters such as color, surface structure, geometry, and material. The louvers can be positioned horizontally (such as shown in FIGS. 10 and 11), vertically, or diagonally, and can be spaced apart evenly (such as shown in FIG. 10) or unevenly (such as shown in FIG. 11) depending on the application and the desired attenuation of light at a particular location. Similarly, the length, width, thickness, and angle of individual louvers can be selected depending on the application and the desired attenuation of light. Alternatively, the louvers can have a honeycomb type construction. The louvers can be made from an opaque light-absorbing material (e.g. black plastic or the material used for computer display privacy filters) or any other suitable material with light-attenuating characteristics. The louvers can be made by injection molding, microreplication, or any other suitable manufacturing method, and can be formed integrally with the viewing surface or separately from the viewing surface. When viewed from side II (see FIGS. 10 and 11), the viewing surface having the louvers is substantially transparent. This can be determined by the amount of light transmission and visibility through the viewing surface (including the louvers), i.e. the amount of open area in the viewing surface (including the louvers). To accommodate this function, the louvers can have an open area relative to a typical viewing angle from side II (e.g. a driver's rear view) of about 50% or more, preferably 70% or more, more preferably 90% or more.

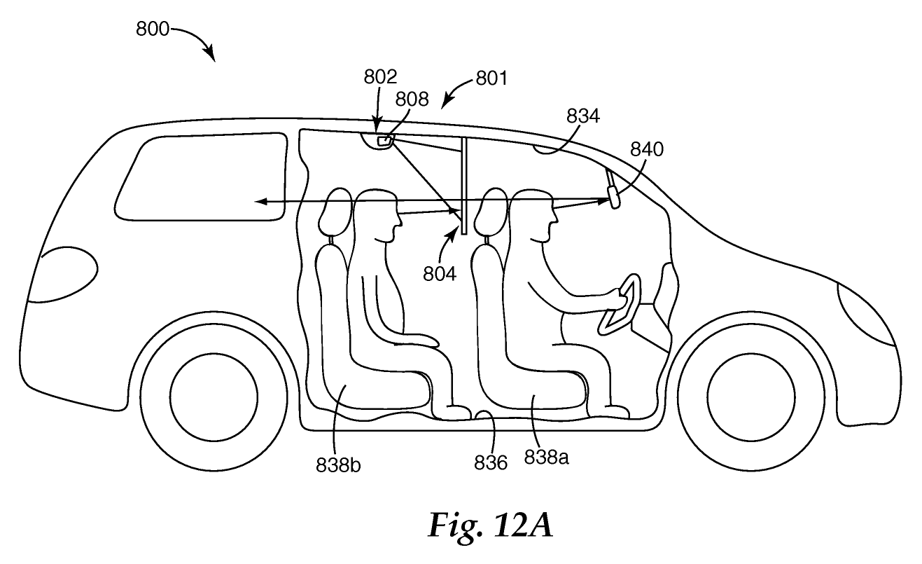

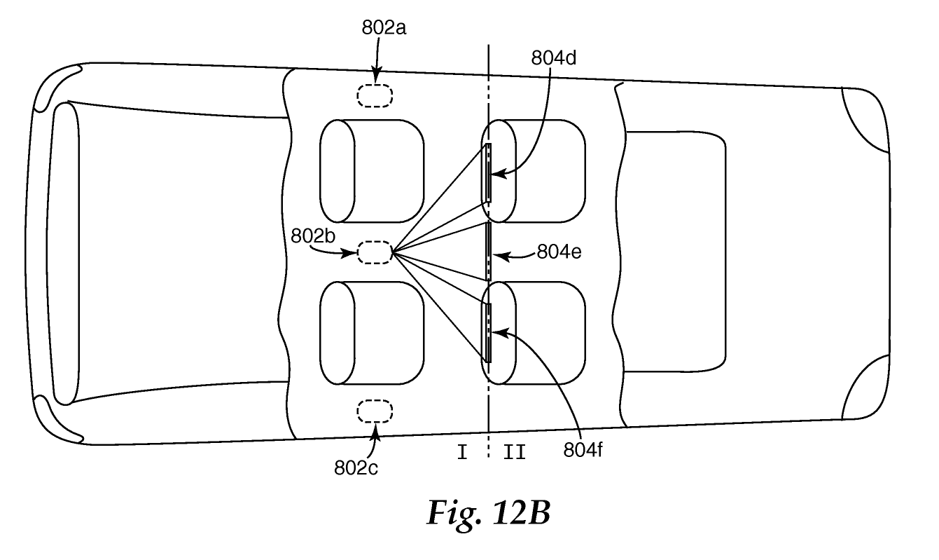

A projection system according to the present invention can be used in a large number of applications, including applications in the automobile, airline, and dynamic signage markets. FIGS. 12A and 12B show an exemplary embodiment of a motor vehicle according to the present invention. A motor vehicle can include an automobile (typically a passenger car, van, or SUV), truck, bus, airplane, helicopter, or other motor-driven conveyance. Motor vehicle 800 includes a ceiling 834, a floor board 836, a plurality of front seats 838a and rear seats 838b, a rear view mirror 840, and a projection system 801 having a projection device 802 and a viewing surface 804. Projection device 802 includes an optical engine 808. Projection system 801 can be any of the projection systems described above.

As shown in FIG. 12A, projection device 802 can be positioned near or on ceiling 834 of motor vehicle 800, e.g. by coupling it to ceiling 834 directly or indirectly (e.g. by using a projection device mount (not shown)). Alternatively, projection device 802 can be positioned near or on floor board 836 or in between rear seats 838b of motor vehicle 800, as shown in FIG. 12B. Generally, projection device 802 can be positioned in any suitable or desired location of a motor vehicle in a suitable position relative to viewing surface 804. Projection device 802 may optionally include or be co-located with a dome light (not shown) that is configured to light the interior of motor vehicle 800. Viewing surface 804 of motor vehicle 800 is substantially diffuse reflective when viewed from the rear passenger side and substantially transparent when viewed from the driver/front passenger side. This enables a rear passenger to view an electronic image projected by projection device 802 on viewing surface 804, while not obstructing or hindering the driver's rear view, e.g. directly (by the driver looking over his or her shoulder), or through rear view mirror 840. In this respect, viewing surface 804 may be placed in many different locations and may be placed within the field of view of a driver looking over his or her shoulder or through a rear view mirror. In one aspect, the direction of the projected light rays departing from projection device 802 can be different from the direction of the driver's rear view. As shown in FIG. 12A, viewing surface 804 can be a projection screen positioned near or on ceiling 834 of motor vehicle 800, e.g. by coupling it to ceiling 834 directly or indirectly (e.g. by using a projection screen mount (not shown)). Alternatively, viewing surface 804 can be positioned in between front seats 838a. Generally, viewing surface 804 can be positioned in any suitable or desired location in a motor vehicle in a suitable position relative to projection device 802.

FIG. 12B shows a top view of the motor vehicle shown in FIG. 12A, where projection device 802 and/or viewing surface 804 can be disposed at one or more different locations in the rear passenger compartment. For example, projection device can be positioned in one or more of locations 802a, b, and c, and viewing surface can be positioned in one or more of locations 804d, e, and f. As illustrated in FIG. 12B, a preferred location of projection device can be location 802b, whereby the projection device can project an electronic image onto a viewing surface positioned in one or more locations 804d, e, and f. In one exemplary aspect, a single projection device 802 can project two or more separate electronic images or programs onto one or more corresponding viewing surfaces 804, e.g. by projecting two 60 Hertz program contents by using a 120 Hertz imaging device, and extracting the two programs to individual viewers.

In one exemplary aspect, motor vehicle 800 can be a taxi cab, wherein viewing surface 804 is or is positioned on a dividing surface (e.g. a perforated metal screen or a transparent plastic or glass window, not shown) placed between the front (taxi driver's) and rear (passenger's) compartment of the taxi. In this aspect, the electronic image projected on the viewing surface can include advertisements or instructional or other information presented to the passenger(s) during a taxi trip.

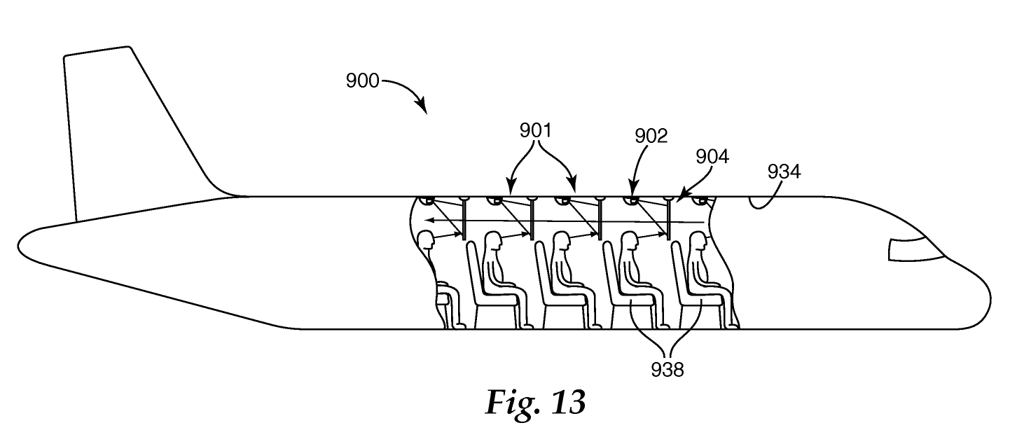

FIG. 13 shows another exemplary embodiment of a motor vehicle (an airplane) according to the present invention. Airplane 900 includes a ceiling 934, a plurality of seats 938, and a plurality of projection systems 901, each having a projection device 902 and a viewing surface 904. Projection systems 901 can be constructed in a manner the same as or similar to any of the projection systems described above. As shown in FIG. 13, each projection device 902 can be positioned near or on a ceiling 934 of airplane 900, e.g. by coupling it to ceiling 934 directly or indirectly (e.g. by using a projection device mount (not shown)). Generally, each projection device 902 can be positioned in any suitable or desired location in an airplane in a suitable position relative to corresponding viewing surface 904. Each viewing surface 904 is substantially diffuse reflective when viewed from the rear side of airplane 900 and substantially transparent when viewed from the front side of airplane 900. This construction enables each passenger to view an electronic image projected by projection device 902 on corresponding viewing surface 904, while not obstructing or hindering the view towards the rear of airplane 900 from the front of the cabin. As shown in FIG. 13, each viewing surface 904 can be a projection screen positioned near or on ceiling 934 of airplane 900, e.g. by coupling it to ceiling 934 directly or indirectly (e.g. by using a projection screen mount (not shown)). Generally, each viewing surface 904 can be positioned in any suitable or desired location in an airplane in a suitable position relative to corresponding projection device 902. In one exemplary aspect, a single projection device 902 can project a separate electronic image onto multiple corresponding viewing surfaces 904, using split image technology. This approach reduces the total number of projection devices needed to provide a relatively large number of individual electronic images, and can be used e.g. in airplane applications.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electromechanical, and electrical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A projection system comprising:
a projection device comprising an optical engine; and
a viewing surface having a first side and a second side, wherein the viewing surface is substantially diffuse reflective when viewed from the first side and substantially transparent when viewed from the second side,
wherein the projection device is configured to project an image onto the viewing surface.

2. The projection system of claim 1, wherein the viewing surface comprises a perforated projection screen.

3. The projection system of claim 1, wherein the viewing surface comprises:
a transparent substrate;
a light-reflective coating disposed on one side of the substrate and having a plurality of openings; and
a light-absorbing coating disposed on and in register with the light-reflective coating.

4. The projection system of claim 1, wherein the viewing surface comprises a plurality of louvers adapted to attenuate light passing through the viewing surface.

5. The projection system of claim 1, wherein the optical engine has a throw ratio of about 2.0 or less.

6. The projection system of claim 1, wherein the optical engine has a throw ratio of about 1.5 or less.

7. The projection system of claim 1, wherein the optical engine has a throw ratio of about 1.0 or less.

8. The projection system of claim 1, wherein the optical engine is disposed in a housing.

9. The projection system of claim 1, wherein the projection system has an offset of 0% to 300%.

10. The projection system of claim 1, wherein the projection system has an offset of 100% to 200%.

11. The projection system of claim 1, wherein the image comprises a moving image.

12. The projection system of claim 1, wherein the projection device is configured to project two or more separate images onto one or more viewing surfaces.

13. A projection screen comprising:
a viewing surface having a first side and a second side, wherein the viewing surface is substantially diffuse reflective when viewed from the first side and substantially transparent when viewed from the second side; and
a plurality of louvers connected to the viewing surface and adapted to attenuate light passing through the viewing surface.

14. The projection screen of claim 13, wherein the plurality of louvers has an open area of about 50% or more.

15. The projection screen of claim 13, wherein the plurality of louvers has an open area of about 70% or more.

16. The projection screen of claim 13, wherein the plurality of louvers has an open area of about 90% or more.

17. The projection screen of claim 13, wherein the plurality of louvers has a louver width to louver spacing ratio of about 50 or less.

18. The projection screen of claim 13, wherein the plurality of louvers has a louver width to louver spacing ratio of about 20 or less.

19. A motor vehicle comprising:
a projection system comprising:
a projection device comprising an optical engine; and
a viewing surface having a first side and a second side, wherein the viewing surface is substantially diffuse reflective when viewed from the first side and substantially transparent when viewed from the second side,
wherein the projection device is configured to project an image onto the viewing surface.

20. The motor vehicle of claim 19, wherein the viewing surface comprises a perforated projection screen.

21. The motor vehicle of claim 19, wherein at least one of the projection device and the viewing surface is positioned in a rear passenger compartment of the motor vehicle.

22. The motor vehicle of claim 19, wherein the projection device is coupled to a ceiling of the motor vehicle.

23. The motor vehicle of claim 19, wherein the projection device is coupled to a floor board of the motor vehicle.

24. The motor vehicle of claim 19, wherein the projection device is positioned in an internal compartment of a ceiling of the motor vehicle.

25. The motor vehicle of claim 19, wherein the projection device is co-located with a dome light of the motor vehicle.

26. The motor vehicle of claim 19, wherein the image comprises a moving image.

27. The motor vehicle of claim 19, wherein the projection device is configured to project two or more separate images onto one or more viewing surfaces.
